(19) United States
(12) Patent Application Publication
(10) Pub. No.: US 2007/0008528 A1
(43) Pub. Date: Jan. 11, 2007

(54) Device and method for simultaneous optical trapping, stretching, and real-time detection and measurement for morphological deformation of micro-particles

(75) Inventors: Arthur Chiou, Taipei City (TW); Chi-Hung Lin, Taipei City (TW); Artashes Karmenyan, Taipei City (TW); I Ching Hsiao, Taipei City (TW)

Correspondence Address: BACON & THOMAS, PLLC, 625 SLATERS LANE, FOURTH FLOOR, ALEXANDRIA, VA, 22314, US

(73) Assignee: Chi-Hung Lin, Taipei City (TW)

(21) Appl. No.: 11/175,140

(22) Filed: Jul. 7, 2005

(51) Int. Cl. G01N 21/00; G01B 11/24

(52) U.S. Cl. 356/338; 356/601

(57) ABSTRACT

The present invention provides a method and device for simultaneous optical trapping, stretching, and measurement of morphological deformation of a micro-particle in real-time. Using the setup of the present invention, the deformability of a living cell can be obtained in real-time by measuring the variation in coupling efficiency with optical power of light coupled from one single-mode fiber to the other through the lensing effect of the trapped-and-stretched micro-particle.

### BACKGROUND OF THE INVENTION

1. Field of the Invention

The present invention is related to a method and device for simultaneous trapping, stretching, and real-time measurement of morphological deformation of a particle with extremely high sensitivity. In this invention, the deformability of a particle can be obtained in real-time by measuring the nonlinear coupling efficiency of a laser beam from one single-mode fiber to the other after passing through the micro-particle trapped in a pair of counter-propagating laser beams emitted from the two single-mode fibers.

2. Description of Related Art

Over the past three decades, it has been found that laser can be utilized to capture and manipulate particles and cells with diameters on the order of a micron to tens of microns. The technologies of laser traps or laser tweezers were developed employing laser light to trap or move micro-particles, which are extremely difficult (if not impossible) to move or manipulate by traditional tweezers, to desired positions.

The basic physical principle of manipulating particles by laser light can be explained by viewing the light beam as a stream of photons each bearing a specific amount of momentum and that the change in momentum as the photons are either reflected or refracted by a particle is converted into force on the particle. Under appropriate conditions, the net optical forces can form a three-dimensional potential well to stably confine a micro-particle within a small volume.

Common laser trap devices fall into two categories. One is a single-beam gradient force optical trap, which is also known as laser tweezers. It employs a strongly focused laser beam to form a 3-dimensional potential well, capable of attracting and confining a dielectric particle in the vicinity of the focal spot of the laser beam. Laser tweezers enable us to actively manipulate micro- and nano-particles and to accurately move the particles non-invasively from one point to another. The technology is widely used in various fields of research, especially in biology and physics. In biological studies, laser tweezers can be used to capture and trap cells, investigating dynamics of microtubules, mobile behaviors and characteristics of motor proteins such as dynein and kinesin thereof, studying swimming movements of sperms (Tadir et al., 1990), and investigating polymerization properties of DNA. In addition, laser tweezers contribute greatly to advances in physical and chemical researches, especially in colloid and interface sciences. Potential optical damage of the particles of interest caused by the strongly focused laser beam has also been thoroughly investigated; it was found that the optical power required for stable trapping can be much lower than the optical damage threshold as long as the particle is not strongly absorptive at the wavelength of light used for trapping.

An alternate approach is a counter-propagating dual-beam trap, in which a particle is illuminated from two opposite sides by two co-linear laser beams propagating along opposite directions, generating optical pressure on the surface of the particle and forming an optical trap-and-stretch. If the particle, for example, a cell, is flexible, it will be stretched and will deform in the direction along the optical axis. Furthermore, because no strong focusing (of laser beams) is required, the probability of optical damage to the particle is significantly reduced. In the observations of cells such as human red blood cells and mice fibroblasts, it is discovered that the extent of deformation differs with the cell types (Guck et al., 2001). However, the approach reported by Guck depends on post-detection image processing and analysis with limited sensitivity.

Prior studies have shown that the maintenance of cell shapes is closely related to cytoskeleton proteins. Cytoskeleton proteins are tightly connected to membranes and organelles in cells. Cytoskeletons are disconnected from cell membranes and destabilized upon attack, resulting in changes in morphology and mobility of the cells. The mechanism for this could be attributed to: (1) a series of abnormal polymerization and depolymerization of actin filament proteins; (2) damages in proteins anchoring cytoskeleton proteins to cell membranes; and (3) Loss or destruction of cytoskeleton-protein-stabilizing thiol, which destabilizes the structure of actin filaments. Changes in physical properties of cell surfaces are important signs of many diseases, and it is known that certain carcinogens elicit cellular toxicity and cause changes in cell shapes. Besides, the shape of many cancer cells are different from that of the corresponding normal cells, indicating changes in the structure of cytoskeletons. We believe further promoting applications of Optical Stretcher techniques will not only benefit the understanding of the structure of cytoskeletons, but also help studies on diseases, and solving the problems in cellular dynamics.

### SUMMARY OF THE INVENTION

In light of the above drawbacks of the prior arts, the objective of the present invention is to provide a method and a device to detect and measure morphological deformation of a particle in real-time. To be more specific, the method and device of the present invention detect morphological deformation of the particle by measuring the change in coupling efficiency with optical power for light coupling from one single-mode fiber to the other through the trapped-and-stretched particle.

It is therefore an objective of the present invention to provide a device for real-time detection and measurement of morphological deformation of a particle, comprising: a laser light source; an isolator for blocking the laser light reflected from the output side of said isolator; a plurality of couplers for splitting the laser light into different single mode fibers; a plurality of power meters each of which having a photo-detector for measuring optical power; a plurality of fiber circulators for bypassing the laser light in reverse direction into a separate channel; a stage for loading the particle to be observed; a plurality of single mode fibers connecting said isolator, said couplers, said power meters, said fiber circulators and said stage for transmitting the laser light there between; an objective lens for observing deformation of the particle; a CCD camera in a image plane of said objective for observing images of particles in a focal plane of said objective ; and a computer for processing obtained data.

Another objective of the present invention is to provide a method for real-time detection and measurement of morphological deformation of a particle using the aforementioned device, said method comprising: (a) obtaining a particle to be measured; (b) generating laser light, splitting the laser light into two laser beams by the fiber Y-coupler, and then respectively illuminating both sides of the particle through two single mode fibers; (c) measuring a reference optical power and an output optical power, respectively; and (d) comparing said reference optical power and said output optical power, thereby the extent of deformation of said particle is detected and measured.

A further objective of the present invention is to provide a method for obtaining a deformation calibration curve using the aforementioned device, comprising: (a) obtaining a particle to be measured; (b) generating laser light, splitting the laser light into two laser beams by the fiber Y-coupler, and then respectively illuminating both sides of said particle through two single mode fibers; (c) measuring a reference optical power and an output optical power, respectively; (d) changing optical power of the laser light generated by said laser light source; (e) respectively measuring said reference optical power and said output optical power again; (f) repeating steps(d) and (e) at least seven times; and (g) obtaining a deformation calibration curve according to data obtained by steps(c) through (f).

Yet another objective of the present invention is to provide a method for real-time detection and measurement of morphological deformations of different small particles using the aforementioned device, comprising: (a) obtaining different particles to be measured; (b) generating laser light, splitting the laser light into two beams by the fiber Y-coupler, and then respectively illuminating said each particle through two single mode fibers; (c) measuring a reference optical power and an output optical power, respectively; (d) changing optical power of the laser light generated by said laser light source; (e) respectively measuring the reference optical power and the total output optical power again; (f) repeating steps(d) and (e) at least seven times; and (g) obtaining a deformation calibration curve according to data obtained by steps(c) through (f); and (h)comparing the profiles of said deformation calibration curves of each said particle to obtain the extent of deformation of each said particle.

The power of input laser light serves as the reference optical power set forth. The aforementioned output optical power is defined as the power of each laser light that has passed through the particle to be observed and then entered said single mode fibers at the opposite ends of said sample stage.

The present invention provides the following advantages over prior arts. First, the detection of deformation according to the present invention does not require imaging processing processes that are costly both in measurement and time. Second, the whole device is all-fibered, considerably reducing the use of optical and mechanical elements, saving the time taken in tedious calibration, and increasing efficiency of detection. Third, the device adopts an all-fiber mode, which greatly lowers the instability and uncertainty caused by aging and loosening of the optical or mechanical elements, so that the detection sensitivity of the device is increased. Fourth, the all-fibered device occupies less space and is able to be developed into a portable instrument for detection and measurement. Fifth, incorporating with microfluidic cell transportation chips, it is possible to capture the particle to be measured, conducting real-time detection of deformation, thereby increasing efficiency of the measurement. Finally, deformation of particles is readily detected without the needs to focus the light and to use high intensity, preventing the particle from potential optical damages.

### BRIEF DESCRIPTION OF THE DRAWINGS

FIG. 1 illustrates an all-fiber double-beam optical trap device of the present invention.

### DETAILED DESCRIPTION OF THE INVENTION

The present invention provides a device and method for real-time detection and measurement of morphological deformation of a particle, which utilize a fiber-optical dual-beam trap to trap several kinds of particles for observing deformation caused by laser light. The invention detects deformation of the particle by measuring the intensity of the laser light after passing through the particle and the optical fibers. The principle is that when the laser light passes through a particle, the particle behaves like a lens which can focus the laser light. Consequently, when the particle undergoes different extents of deformation, the deformation leads to a change in curvature of the lens, thereby affecting the focusing of the laser light, and hence the coupling efficiency into the optical fibers. In other words, when the particle is stretched by the laser light, different extents of deformation correspond to different intensity of the laser light after passing through the particle and the fibers. The resulting deformation calibration curves vary with different particles.

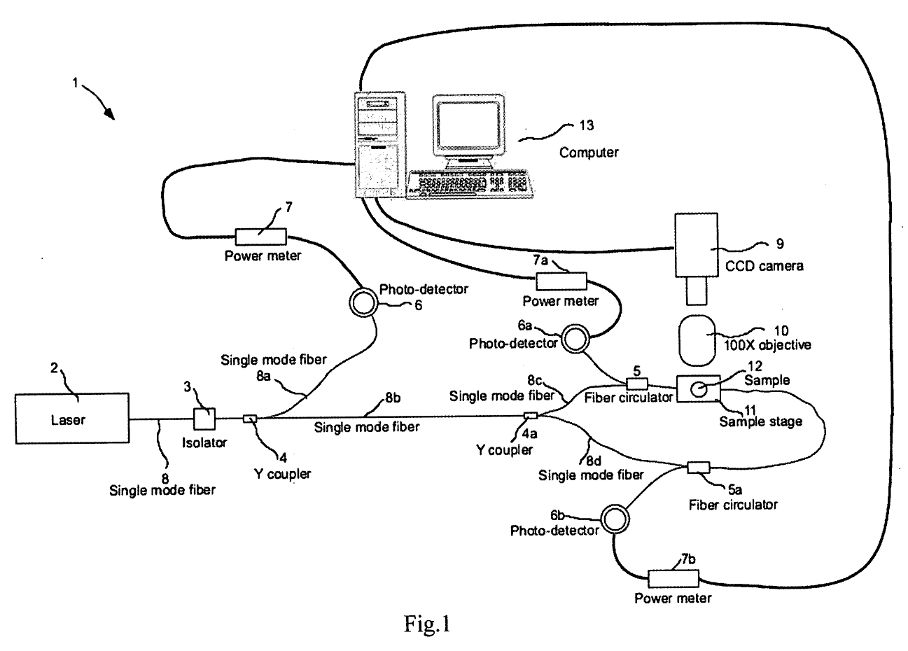

FIG. 1 shows the all-fiber double-beam optical trap device 1 of the present invention. The laser light generated by a laser light source 2 enters a single mode fiber 8 connected to the laser light source 2, and then passes through an isolator 3 used to block the laser light reflected from the output side of the isolator 3.Then the laser light is split into two different single mode fibers 8a and 8b by a Y-coupler 4. One of the two single mode fibers 8a transmits a small fraction of the light (for example, on the order of 1% or less) to a photo-detector 6 of the power meter 7 to be recorded as reference optical power. The other single mode fiber 8b transmits the remaining light to a fiber Y-coupler 4a where the laser light is split into two beams and introduced into two different single mode fibers, 8c and 8d, which are connected to fiber circulators 5 and 5a, respectively, and a sample stage 11 under careful aligmnent such that the two laser beams emitting from the two single mode fibers 8a and 8b are perfectly aligned co-linearly and co-axially. The two laser beams then pass through a particle to be measured on the stage 11 in opposite directions and enter the single mode fibers 8c and 8d at both sides of the particle. The two laser beams are side-channeled by the fiber circulators 5 and 5a to the photo-detector 6a of the power meter 7a and photo-detector 6b of the power meter 7b, respectively, by which the output optical power is measured. Deformation of the particle is observed through a long-working-distance objective lens 10 in conjunction with a CCD camera 9 for observing images in the objective 10. Finally, data obtained from the CCD camera 9 and photo-detector 6, 6a, and 6b of power meter 7, 7a, and 7b are transmitted to a computer 13 for further processing and calculation, thereby the deformation of the particle can be determined once a calibration curve has been obtained.

The particle to be measured in the invention can be a cell, for example, but not limited to, a eukaryotic cell or a prokaryotic cell. The conditions of the cell can be healthy or sick, for example, but not limited to, a cancer cell, a cell at various stages of cell cycle, or a cell treated by reagents or drugs.

To obtain particle deformation calibration curves by the method of the invention, it is necessary to measure at least seven times (to ensure accuracy) the reference optical power (via power meter 7) before and the output optical power (via power meters 7a and 7b) after passing through the particle and the fibers. The data are converted to curves.

Other features, techniques and efficacy of the present invention will be readily apparent from the following description of the preferred embodiments thereof, taken in conjunction with accompanying drawings. Those embodiments serve as further explanations of the advantages of the present invention, not limitations of the claims.

### EXAMPLE 1

This example illustrates the operation of the all-fiber double-beam optical trap device 1 as shown in FIG. 1. The laser light with a wavelength of 980 nm generated by a cw semiconductor laser light source 2 enters a single mode fiber 8 connected to the laser light source 2, and then passing through an isolator 3 used to block the laser light reflected from the output side of the isolator 3. Subsequently, the laser light is split into two different single mode fibers 8a and 8b by a Y coupler 4. One of the two single mode fibers 8a transmits 1% of the light to the photo-detector 6 of the power meter 7 to be recorded as reference optical power. The other single mode fiber 8b transmits the remaining 99% light to a Y-coupler 4a to split the light with equal optical power into two single mode fibers 8c and 8d, which are connected to fiber circulators 5 and 5a, respectively, and a sample stage 11 under careful alignment such that the two laser beams emitting from the two single mode fibers 8a and 8b are perfectly aligned co-linearly and co-axially.. The two laser beams then pass from opposite directions through a particle 12 to be measured on the stage 11 and enter the single mode fiber 8c and 8d at opposite sides of the particle 12. The two laser beams are side-channeled by the fiber circulators 5 and 5a to the photo-detector 6a of the power meter 7a and photo-detector 6b of the power meter 7b, respectively, by which the output optical power is measured. Deformation of the particle 12 is observed through a long-working-distance 100× objective lens 10 equipped with a CCD camera 9 for observing images in the objective lens 10. Then obtained data, such as the images from the objective lens 10 and different optical power from the photo-detector 6, 6a, and 6b of the power meter 7, 7a, and 7b are transmitted to a computer 13 for further processing and calculation to obtain a morphological deformation of the particle 12.

The method of the present invention can also be applied to detection of sick cells, including changes in physical properties of cells (as an indicator of inflammation, for instance) resulting from interactions of cells with cytokines and other biological molecules. Changes in the composition of the cytoskeleton proteins are important signs of many diseases, and those changes possibly result in differences in elasticity and texture of cell surfaces between sick and normal cells. Such differences suggest different extents of deformation of normal and sick cells responding to the laser light of the same intensity.

The method of the present invention can also be applied to cellular responses to physical and chemical changes in the environment (such as osmotic pressure, temperatures, or pH values, which can be taken as clinical indicators.), and cells at different stages of cell cycle. Cells at different cell cycle stages have different compositions of cytoskeleton proteins, so the cell surface texture and elasticity also varies, leading to various extents of deformation under the same laser light intensity. By the aforementioned steps, it is possible to distinguish cells in different cell cycle stages on the basis of the extents of deformation of the cells.

While the foregoing description and drawings represent the present invention, it will be obvious to those skilled in the art that various changes may be made therein without departing from the true spirit and scope of the present invention.

What is claimed is:

1. A device for real-time detection and measurement of morphological deformation of a particle, comprising:
a laser light source;
an isolator for blocking the laser light reflected from an output side of said isolator;
a plurality of couplers for splitting the laser light into different single mode fibers;
a plurality of power meters each of which having a photo-detector for measuring optical power;
a plurality of fiber circulators for sending the laser light in the forward direction and by passing the laser light in reverse direction into a separate channel;
a stage for loading the particle to be observed;
a plurality of single mode fibers connecting said isolator, said couplers, said power meters, said fiber circulators and said stage for transmitting the laser light there between;
an objective for observing deformation of the particle;
a CCD camera in a image plane of said objective for observing images of particles in a focal plane of said objective ; and
a computer for processing obtained data.

2. The device according to claim 1, wherein said power meters comprise a first power meter with its own photo-detector, a second power meter with its own photo-detector, and a third power meter with its own photo-detector.

3. The device according to claim 2, wherein said first power meter is used to measure power of input laser light, which serves as reference optical power.

4. The device according to claim 2, wherein said second power meter and third power meter are used to measure output optical power defined as the power of each laser light that has passed through the particle to be observed and then entered said single mode fibers at the opposite ends of said sample stage.

5. The device according to claim 1, wherein said objective is a 100× long-working-distance objective lens.

6. The device according to claim 1, wherein said couplers are Y couplers.

7. A method for real-time detection and measurement of morphological deformation of a particle using the device of claim 1, comprising:
(a) obtaining a particle to be measured;
(b) generating laser light, splitting the laser light into two laser beams by said Y-coupler, and then respectively illuminating both sides of the particle through two single mode fibers;
(c) measuring a reference optical power and an output optical power, respectively; and
(d) comparing said reference optical power and said output optical power, thereby the extent of deformation of said particle is detected and measured.

8. The method according to claim 7, wherein said particle is a cell;

9. The method according to claim 8, wherein said cell comprises an eukaryotic cell or a prokaryotic cell;

10. The method according to claim 8, wherein said cell comprises a healthy cell or a sick cell;

11. The method according to claim 7, wherein the extent of deformation of said particle is obtained from a pre-determined deformation calibration curve;

12. A method for obtaining a deformation calibration curve using said device of claim 1, comprising:
(a) obtaining a particle to be measured;
(b) generating laser light, splitting the laser light into two laser beams by said Y-coupler, and then respectively illuminating both sides of said particle through two single mode fibers;
(c) measuring a reference optical power and a output optical power, respectively;
(d) changing optical power of the laser light generated by said laser light source;
(e) respectively measuring a reference optical power and an output optical power again;
(f) repeating steps(d) and (e) at least seven times; and
(g) obtaining a deformation calibration curve according to data obtained by steps(c) through (f)

13. The method according to claim 12, wherein said particle is a cell;

14. The method according to claim 13, wherein said cell comprises an eukaryotic cell or a prokaryotic cell;

15. The method according to claim 13, wherein said cell comprises a healthy cell or a sick cell;

16. A method for real-time detection and measurement of morphological deformation of different small particles using said device of claim 1, comprising:
(a) obtaining different particles to be measured;
(b) generating laser light, splitting the laser light into two beams by said Y-coupler, and then respectively illuminating said each particle through two single mode fibers;
(c) measuring a reference optical power and an output optical power, respectively;
(d) changing optical power of the laser light generated by said laser light source;
(e) respectively, measuring said reference optical power and said output optical power again;
(f) repeating steps(d) and (e) at least seven times; and
(g) obtaining a deformation calibration curve according to data obtained by steps(c) through (f); and
(h) comparing the profiles of said deformation calibration curves of each said particle to obtain the extent of deformation of each said particle .

17. The method according to claim 16, wherein said particle is a cell.

18. The method according to claim 17, wherein said particle comprises healthy cells, sick cells, cells at various cell cycle stages, cells treated by reagents and drugs.
